(19) United States
(12) Patent Application Publication
(10) Pub. No.: US 2006/0266713 A1
(43) Pub. Date: Nov. 30, 2006

(54) Floor panel and method for producing the same

(75) Inventor: Donald R. Gearhart, Macomb, MI (US)

Correspondence Address: BRINKS HOFER GILSON & LIONE, P.O. BOX 10395, CHICAGO, IL, 60610, US

(73) Assignee: W.K, Industries, Inc.

(21) Appl. No.: 11/135,772

(22) Filed: May 24, 2005

(51) Int. Cl. C02F 1/00

(52) U.S. Cl. 210/767

(57) ABSTRACT

A floor panel having a first and second layer. The first and second layer including polypropylene resin. The floor panel also including a foam layer located between the first and second layer. The first and second layer are bonded along an edge region to encapsulate the foam layer. In addition, the first layer defines a recess in a middle portion of the floor panel, wherein the recess includes a region where the first and second layer are bonded together.

### BACKGROUND

1. Field of the Invention

The present invention generally relates to a floor panel especially adapted for a motor vehicle and method for producing the same.

2. Description of Related Art

Typically, floor panels for vehicles, such as the panel that covers a rear tire in the trunk of a sport utility vehicle are typically made of a wood or compressed fiber material. The compressed panels provide a fairly lightweight and low cost option for covering the spare tire and vehicle underbody from the user. In addition, materials are usually attached to the compressed boards allowing them to easily match the interior of the vehicle or other compartment trim.

However, often over time the compressed board panels will absorb water or fatigue causing eventual warping or failure of the board. More recently, floor panels have been made from blow molded polypropylene. However, these panels are often heavier than the compressed board panels and offer similar durability.

In view of the above, it is apparent that there exists a need for an improved floor panel and method for producing the same.

### SUMMARY

In satisfying the above need, as well as overcoming the enumerated drawbacks and other limitations of the related art, the present invention provides an improved floor panel and method for producing the same.

The floor panel of this invention has a first and second layer. The first and second layer including about 45% polypropylene resin and about 55% glass fiber. The floor panel also including a foam layer, such as an expanded polypropylene foam, located between the first and second layer.

The first and second layer are bonded along their edges to encapsulate the center foam layer. The bonded edges may form a flange extending beyond the foam layer. In addition, the first layer defines a recess in a middle portion of the floor panel wherein the recess includes a region where the first and second layer directly contact one another and in such a region are bonded together. Further, the floor trim panel may include an array of recesses wherein each recess forms a bonded region between the first and second layer and each bonded region is preferably less than 12 inches from another bonded region.

In another aspect of the present invention, a method for manufacturing the panel is provided. A first sheet of so-called super light material is heated and positioned within the tooling. A foam sheet is located over the first sheet and aligned with respect to the tool. A second super light material sheet is heated and positioned over the foam sheet. The tool is closed, applying pressure to the second sheet thereby bonding the second sheet to the first sheet and encapsulating the foam layer. Further, as mentioned above, recesses may be formed through the foam sheet forming additional bonded regions between the first and second sheet.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a top view of the floor trim panel in accordance with the present invention;

FIG. 2 is a sectional side view along section line 2-2 in FIG. 1;

FIG. 3 is a sectional side view of the floor panel section along line 3-3 in FIG. 1;

FIG. 4 is a flow chart of a method for producing the floor panel in accordance with the present invention;

FIG. 5 is a side view of the heating process in accordance with the present invention; and

FIG. 6 is a sectional side view of the forming process in accordance with the present invention.

### DETAILED DESCRIPTION

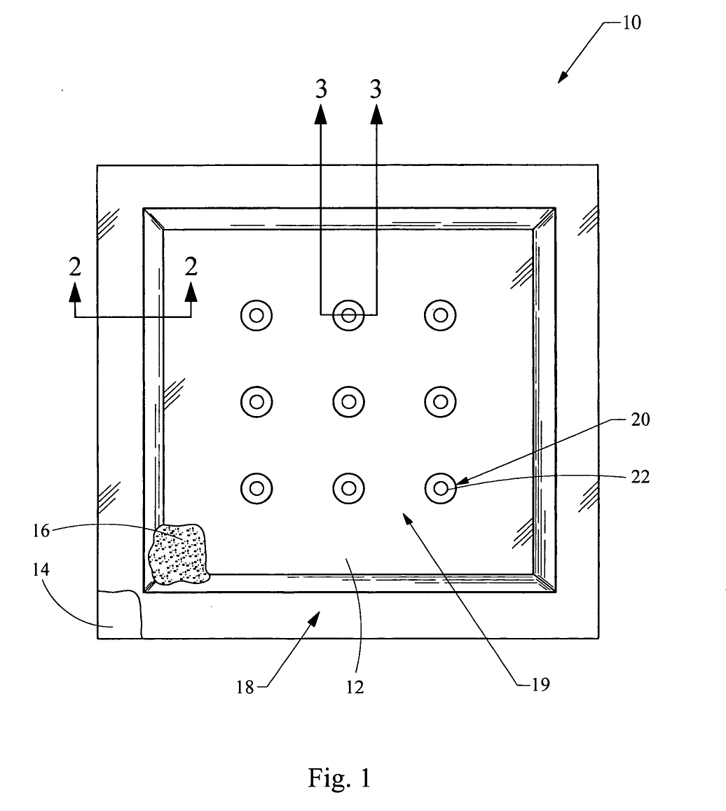

Referring now to FIG. 1, a floor panel embodying the principles of the present invention is illustrated therein and designated at 10. As its primary components, the floor panel 10 includes a first layer 12, a second layer 14, and a foam layer 16.

The first and second layer 12 and 14 are preferably made from a super light material, such as Azdel™ material manufactured by General Electric Plastics. One example of super light material is made of 35-55% polypropylene resin and 45-65% fibrous filler material, more preferably 55% glass fiber and about 45% polypropylene resin. The super light material may be supplied in sheets of various weights ranging from 800 to 2000 grams per square meter. The foam layer 16 is fully enclosed by the first layer 12 and the second layer 14. The foam layer 16 is made of an expanded polypropylene foam. The first layer 12 is bonded to the second layer 14 at an edge region 18 around the perimeter of the floor panel 10. The bond around the edge region 18 fully encapsulates the foam layer 16. In addition, a middle portion 19 of the floor panel 10 may have one or more recesses 20 forming a region 22 where the first layer 12 extends through the foam layer 16 and bonds with the second layer 14. Creating multiple recesses 20 with bonded regions 22, helps to prevent delamination and improve the rigidity of the floor panel 10. Preferably, each bonded region 22 is less than 12 inches from another bonded region 22 or the edge region 18.

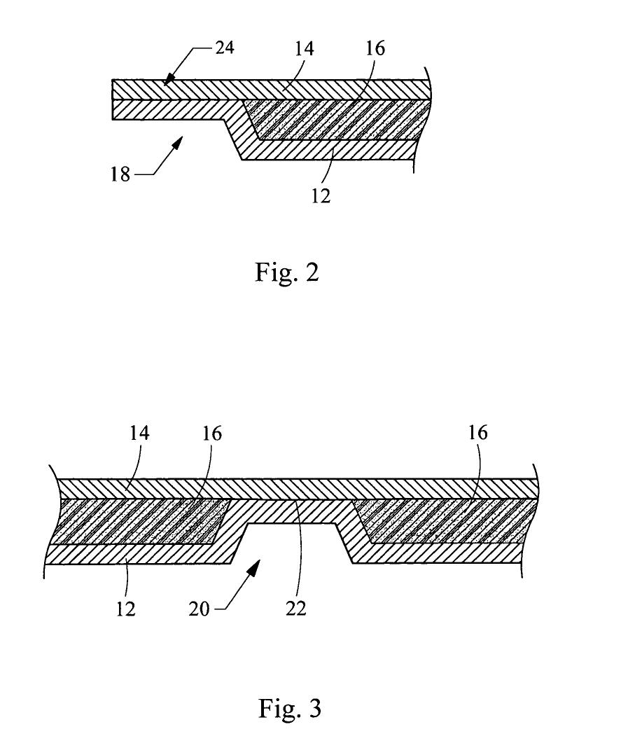

Now referring to FIG. 2, a cross-sectional view is shown along line 2-2 of FIG. 1. As discussed previously, the foam layer 16 is shown located between the first layer 12 and the second layer 14. Further, an edge region 18 of the first layer 12 and second layer 14 are bonded forming a flange 24 extending from the foam layer 16. For a typical panel 10, the thickness of the first layer 12, the second layer 14 and foam layer 16 combined is preferably about 19 millimeters. While the thickness at the edge region 18 where the first layer 12 is bonded to the second layer 14 is about 3 millimeters thick. The flange 24 formed at the edge region 18 extends about 12 millimeters from the foam layer 16 and fully encapsulating the foam layer 16.

Now referring to FIG. 3, a cross-sectional view along line 3-3 of FIG. 1 is provided. A profile of the recess 20 is provided more detail in this cross-sectional view. The recess 20 is formed by a portion of the first layer 12 extending through the foam layer 16 and bonding with the second layer 14. The bond extends along region 22 of the recess 20. The recess 20 has a generally conical shape with a surface angle of 20° with respect to the surface of the bonded region 22. The 20° angle provides ease of insertion and removal for tooling. The bonded region 22 has a diameter of 15 millimeters and a thickness of about 3 millimeters along the bonded region 22. While the generally conical shape provides for ease of manufacture, other shapes or even troughs may be used to form a recess where the first and second layer 12, 14 are bonded to prevent delamination.

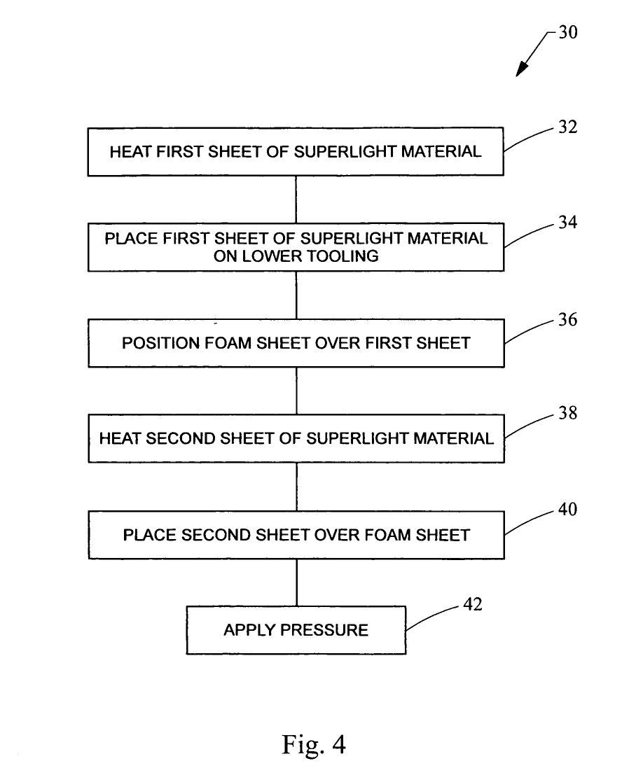

Now referring to FIG. 4, a flow chart of a method 30 for making a floor panel in accordance with the present invention is provided. The method 30 starts in block 32 where a first sheet of super light material is heated to a temperature of approximately 400° F. The first sheet is placed on the lower tooling as noted by block 34. In block 36, a foam sheet is positioned over the first sheet of super light material. The foam sheet must be accurately positioned during the forming process. Accurate positioning can be achieved utilizing swing arm locators or a laser beam projection. The swing arm locators can be moved into the tooling to align the sheet and then swung out prior to the close of tooling. Similarly, the laser beam projection would project beams into the tooling to visually aid in alignment of the foam sheet. In block 38, a second sheet of super light material is heated to a temperature of approximately 400° F. The second sheet of super light material is placed over the foam sheet, as denoted by block 40. In block 42, the upper tool is closed applying pressure on the first sheet of super light material, the second sheet of super light material, and the foam sheet. Very low pressure is required to form the panels, therefore, aluminum tooling can be used in production while providing solid tool life. This can provide significant cost advantages and ease of tool maintenance. The pressure used to form the panels is approximately 10 to 50 pounds per square inch.

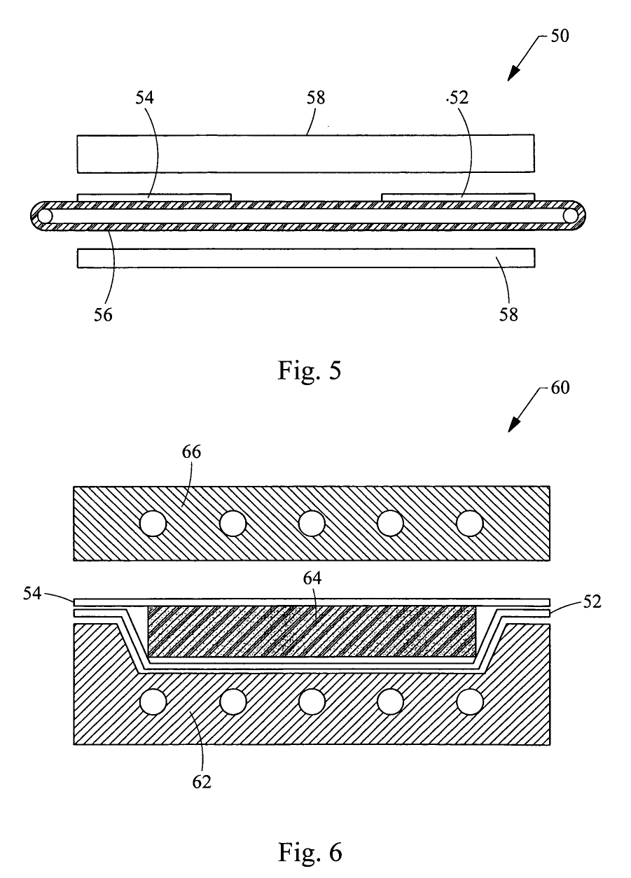

Now referring to FIG. 5, a side view of the heating process is provided. A first sheet 52 and a second sheet 54 are shown being heated in an oven 50. The oven 50 is a conveyor-type oven where the first and second sheet 52, 54 are translated through the oven 50 on a conveyor 56. Heating elements 58 may be provided above and below the conveyor to heat the first and second sheet 52, 54 to a temperature of approximately 400° F.

Now referring to FIG. 6, the first sheet 52 is taken from the conveyor 56 and is positioned on the lower portion 62 of the tooling 60. Next, a foam sheet 64 is located on the first sheet 52. The foam sheet 64 is aligned relative to the tooling 60. The second sheet 54 is then located on top of the foam sheet 64 and the first sheet 52. The top portion 66 of the tooling 60 closes on the second layer 54 applying approximately 10 to 50 pounds per square inch of pressure to the assembly. The heat of the first and second sheet 52, 54 and the pressure provided by the tooling 60 forms a bond between the first and second sheet 52, 54, for example, along the edge regions 18 and the bonded regions 22 of FIG. 1. Further, a bond is formed both between the first sheet 52 and the foam sheet 64, and between the second sheet 54 and the foam sheet 64. The result is a rigid lightweight floor panel with a very low thermal expansion coefficient.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I claim:

1. A floor panel for a vehicle the floor panel comprising:
a first layer including a polypropylene resin and a fibrous filler material;
a second layer including the polypropylene resin and the fibrous filler material; and
a foam layer located between the first and second layer wherein an edge region of the first and second layer are bonded to enclose the foam layer.

2. The floor panel according to claim 1, wherein the fibrous filler material includes glass fiber.

3. The floor panel according to claim 1, wherein the first and second layer include about 45% polypropylene resin.

4. The floor panel according to claim 3, wherein the first and second layer include about 55% glass fiber.

5. The floor panel according to claim 1, wherein the foam layer includes an expanded polypropylene foam.

6. The floor panel according to claim 5, wherein the edge region of the first and second layer form a flange extending from the foam layer.

7. The floor panel according to claim 1, wherein the first and second layer define a recess in a middle portion of the floor panel and the first and second layer are bonded along a region of the recess.

8. The floor panel according to claim 7, wherein the recess has a generally conical shape.

9. The floor panel according to claim 1, further comprising a plurality of recesses wherein each recess of the plurality of recesses forms a bonded region between the first and second layer and each bonded region less than 12 inches from another bonded region.

10. A floor panel for a vehicle the floor panel comprising:
a first layer including about 35-55% polypropylene resin and about 45-65% glass fiber;
a second layer including about 35-55% polypropylene resin and about 45-65% glass fiber; and
a foam layer located between the first and second layer, wherein the first and second layer are bonded along an edge region to encapsulate the foam layer.

11. The floor panel according to claim 10, wherein the foam layer includes an expanded polypropylene foam.

12. The floor panel according to claim 10, wherein the edge region of the first and second layer form a flange extending from the foam layer.

13. The floor panel according to claim 10, wherein the first and second layer define a recess in a middle portion of the floor panel and the first and second layer are bonded along a region of the recess.

14. The floor panel according to claim 13, wherein the recess has a generally conical shape.

15. The floor panel according to claim 10, further comprising a plurality of recesses wherein each recess of the plurality of recesses forms a bonded region between the first and second layer and each bonded region less than 12 inches from another bonded region.

16. A method for manufacturing a panel, the method comprising:
providing a tool having a first portion and a second portion;
providing a first sheet including approximately about 45% polypropylene resin and about 55% glass fiber;
heating the first sheet;
positioning the first sheet on the first portion of the tool;
locating an foam sheet;
aligning the foam sheet with respect to the tool;
providing a second sheet including approximately about 45% polypropylene resin and about 55% glass fiber;
heating the second sheet;
positioning the second sheet over the foam sheet; and
applying pressure to the second sheet thereby bonding the second sheet to the first sheet and encapsulating the foam layer.

17. The method according to claim 16, wherein applying pressure includes forming a recess through the foam sheet thereby bonding the second sheet to the first sheet.

18. The method according to claim 16, wherein first and second sheet are heated to about 400° F.

19. The method according to claim 16, wherein applying pressure includes applying a pressure of between about 10 and 50 pounds per square inch.
